(19) United States
(12) Patent Application Publication
(10) Pub. No.: US 2010/0049805 A1
(43) Pub. Date: Feb. 25, 2010

(54) Selection and Delivery of Messages Based on an Association of Pervasive Technologies

(75) Inventors: Robert Lee Angell, Salt Lake City, UT (US); Robert R. Friedlander, Southbury, CT (US); James R. Kraemer, Santa Fe, NM (US)

Correspondence Address: DUKE W. YEE, YEE AND ASSOCIATES, P.C., P.O. BOX 802333, DALLAS, TX, 75380, US

(73) Assignee: INTERNATIONAL BUSINESS MACHINES CORPORATION, Armonk, NY (US)

(21) Appl. No.: 12/193,944

(22) Filed: Aug. 19, 2008

(51) Int. Cl. G06G 7/78; G06F 12/00; G06F 15/16

(52) U.S. Cl. 709/206; 701/300; 707/200

(57) ABSTRACT

A computer implemented method, apparatus, and computer program product for selectively delivering messages. In one embodiment, the process identifies a set of pervasive devices using detection data. The detection data comprises an electronic signature transmitted from the set of pervasive devices associated with a set of users in a monitored location. The process then assigns a demographic profile to each user of the set of users based on an identity of a pervasive device from the set of pervasive devices which is associated with the user. Thereafter, the process presents a set of messages to the set of users, wherein the set of messages are selected using the demographic profile assigned to each user of the set of users.

### BACKGROUND OF THE INVENTION

1. Field of the Invention

The present invention is related generally to a data processing system and in particular to a method and apparatus for selecting and presenting messages. More particularly, the present invention is directed to a computer implemented method, apparatus, and computer usable program code for selecting and presenting messages to users based upon the detection of a set of pervasive devices associated with users in a monitored location.

2. Description of the Related Art

Information may be presented to an audience in the form of messages. The messages may include, for example, transmissions having textual, auditory, or visual content. Examples of messages include, without limitation, news broadcasts, printed advertisements, television commercials, billboard advertisements, text messages, voicemails, and emails. The messages may be presented to the users for different reasons. For instance, messages may be presented to recipients for purposes of providing information, for enticing recipients to purchase advertised products, or to attend an event. Messages, however, may be ignored by the recipient if the information presented therein is irrelevant or is of no interest to the recipient.

### SUMMARY OF THE INVENTION

The illustrative embodiments provide a computer implemented method, apparatus, and computer usable program code for presenting messages. In one embodiment, the process identifies a set of pervasive devices using detection data. The detection data comprises an electronic signature transmitted from the set of pervasive devices associated with a set of users in a monitored location. The process then assigns a demographic profile to each user of the set of users based on an identity of a pervasive device from the set of pervasive devices which is associated with the user. Thereafter, the process presents a set of messages to the set of users, wherein the set of messages are selected using the demographic profile assigned to each user of the set of users.

### BRIEF DESCRIPTION OF THE DRAWINGS

FIG. 1 is a pictorial representation of a network of data processing systems in which illustrative embodiments may be implemented;

FIG. 2 is a block diagram of a data processing system in accordance with an illustrative embodiment of the present invention;

FIG. 3 is a block diagram of a system for use in presenting a set of messages to a set of users in accordance with an illustrative embodiment;

FIG. 4 is a demographic profile in accordance with an illustrative embodiment;

FIG. 5 is a message database record in accordance with an illustrative embodiment;

FIG. 6 is a flowchart of a process for presenting a set of messages to a set of users in accordance with an illustrative embodiment;

FIG. 7 is a flowchart of a process for forming the set of pervasive devices from detection data in accordance with an illustrative embodiment; and

FIG. 8 is a process for presenting a set of messages to a set of users in accordance with an illustrative embodiment.

### DETAILED DESCRIPTION OF THE PREFERRED EMBODIMENT

As will be appreciated by one skilled in the art, the present invention may be embodied as a system, method, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, the present invention may take the form of a computer program product embodied in any tangible medium of expression having computer usable program code embodied in the medium.

Any combination of one or more computer usable or computer readable medium(s) may be utilized. The computer usable or computer readable medium may be, for example but not limited to, an electronic, magnetic, optical, electromagnetic, infrared, or semiconductor system, apparatus, device, or propagation medium. More specific examples (a non-exhaustive list) of the computer readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer usable or computer readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer usable or computer readable medium may be any medium that can contain, store, communicate, propagate, or transport the program for use by or in connection with the instruction execution system, apparatus, or device. The computer usable medium may include a propagated data signal with the computer usable program code embodied therewith, either in baseband or as part of a carrier wave. The computer usable program code may be transmitted using any appropriate medium, including, but not limited to wireless, wireline, optical fiber cable, RF, etc.

Computer program code for carrying out operations of the present invention may be written in any combination of one or more programming languages, including an object oriented programming language such as Java, Smalltalk, C++, or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer readable medium that can direct a computer or other programmable data processing apparatus to function in a particular manner, such that the instructions stored in the computer readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

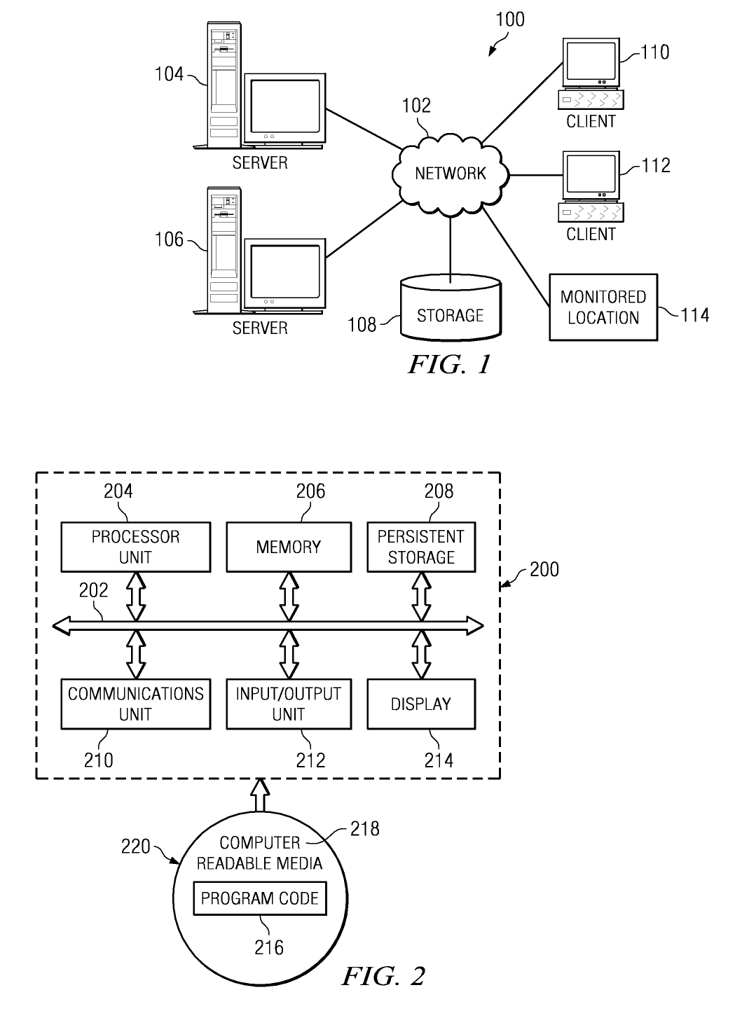

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers that includes network 102. Network 102 is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. Servers 104 and 106 are servers that may store data for use in disseminating selected messages to a set of users according to pervasive devices associated with the set of users. The data stored in the servers may include a collection of messages, a database of devices, and demographics information. Thus, the detection of pervasive devices associated with a set of users may be correlated with demographic data. Messages may be selected from the database of devices based upon the demographic data.

Clients 110 and 112 connect to network 102. Clients 110 and 112 may be, for example, personal computers or network computers. Furthermore, clients 110 and 112 may also be cell phones, personal digital assistants, digital music players, electronic identification tags, or any other pervasive device. A pervasive device is an electronic device capable of generating a unique electronic signature or transmission detectable by signal detectors. The pervasive device may be identified according by the electronic signature emitted from the pervasive device. In the depicted example, server 104 may provide data, such as boot files, operating system images, and applications to clients 110 and 112. Clients 110 and 112 are clients to server 104 in this example. Clients 110 and 112 may be used to host software applications and interface with hardware components for use in presenting messages to users in the possession of or otherwise associated with a set of pervasive devices. Additionally, clients 110 and 112 may also be pervasive devices that are associated with users, the identity of which is used for selecting and presenting messages to the users. A pervasive device may be associated with a user if the user is in the possession of the pervasive device in a monitored location.

In this illustrative example in FIG. 1, network data processing system 100 includes monitored location 114. Monitored location 114 is a location in which people gather or through which people travel. For example, monitored location 114 may be a park, an outdoor market, a supermarket, a strip mall, shopping center, parking lot, or sidewalk. Monitored location 114 may include sensors for detecting the presence of pervasive devices. In addition, monitored location 114 may include display devices for presenting messages based upon the type of pervasive devices detected in monitored location 114.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational, and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments. Network data processing system 100 may include additional servers, clients, and other devices not shown.

Turning now to FIG. 2, a block diagram of a data processing system is depicted in accordance with an illustrative embodiment of the present invention. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor system containing multiple processors of the same type.

Memory 206, in these examples, may be, for example, a random access memory or any other suitable volatile or non-volatile storage device. Persistent storage 208 may take various forms depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard and mouse. Further, input/output unit 212 may send output to a printer. Display 214 provides a mechanism to display information to a user.

Instructions for the operating system and applications or programs are located on persistent storage 208. These instructions may be loaded into memory 206 for execution by processor unit 204. The processes of the different embodiments may be performed by processor unit 204 using computer implemented instructions, which may be located in a memory, such as memory 206. These instructions are referred to as program code, computer usable program code, or computer readable program code that may be read and executed by a processor in processor unit 204. The program code in the different embodiments may be embodied on different physical or tangible computer readable media, such as memory 206 or persistent storage 208.

Program code 216 is located in a functional form on computer readable media 218 that is selectively removable and may be loaded onto or transferred to data processing system 200 for execution by processor unit 204. Program code 216 and computer readable media 218 form computer program product 220 in these examples. In one example, computer readable media 218 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer readable media 218 also may take the form of a persistent storage, such as a hard drive, a thumb drive, or a flash memory that is connected to data processing system 200. The tangible form of computer readable media 218 is also referred to as computer recordable storage media. In some instances, computer readable media 218 may not be removable.

Alternatively, program code 216 may be transferred to data processing system 200 from computer readable media 218 through a communications link to communications unit 210 and/or through a connection to input/output unit 212. The communications link and/or the connection may be physical or wireless in the illustrative examples. The computer readable media also may take the form of non-tangible media, such as communications links or wireless transmissions containing the program code.

The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown.

As one example, a storage device in data processing system 200 is any hardware apparatus that may store data. Memory 206, persistent storage 208 and computer readable media 218 are examples of storage devices in a tangible form.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that may be present in communications fabric 202.

The presentation of messages involves selecting appropriate messages for presentation to a set of recipients. Delivery of messages to recipients may require additional methods of identifying the recipient, their likes and dislikes, and selection of one or more messages based upon that identification. If messages are not properly selected, then the intended recipients may likely ignore the messages. As a result, the sender of the message may incur some form of financial loss, such as lost opportunities, cost of developing the message, and cost of presenting the message. For example, a car dealership may have spent a large sum of money in developing commercials for selling cars. The dealership may purchase a block of time for airing the commercials. If the commercials are aired on a station watched primarily by young children who are not in the market to buy a car, the dealership's investment is wasted. However, if the commercial is presented to members of the public who are old enough to drive and have enough money for purchasing a new car, the seller's commercial may result in increased sales of cars.

Thus, the illustrative embodiments presented herein recognize a need for selecting a set of messages for presentation to a set of recipients. The messages may be selected according to demographics data of the intended recipients. Alternatively, the demographics data may be combined with user profiles for a more granular selection of the set of messages. The demographics data may be identified by identifying the set of pervasive devices in the possession of, or otherwise associated with, a set of users in a monitored location. The set of pervasive devices may include at least one of a cellular telephone, an electronic identification chip, a portable computer, a music player, and a smart phone. As used herein, when used with a list of items, the phrase “at least one of” means that different combinations of one or more of the items may be used, or that only one of each item in the list may be needed. For example, “at least one of item A, item B, and item C” may include, for example and without limitation: item A or item A and item B. This example may also include item A, item B, and item C. Thus, the set of pervasive devices may include a cellular telephone, an electronic identification chip, a portable computer, a music player, a smart phone, or any combination thereof.

Demographics data may be subsequently assigned to or otherwise associated with the users based upon an identity of devices in the set of pervasive devices. The demographics data may be derived or retrieved from a third party source. For instance, market studies may yield demographics data that show purchasers of certain brands of portable music players may be active individuals in a younger age group, with a certain level of income, and who may be more receptive to advertisements for higher end athletic gear. Alternatively, users of a certain brand of smart phone may be a longtime employee of a corporation who would be interested in receiving messages including information about business offers, conferences, or news pertaining to the stock market.

Therefore, the illustrative embodiments provide a computer implemented method, apparatus, and computer program product for presenting messages. In one embodiment, the process identifies a set of pervasive devices using detection data. The detection data comprises an electronic signature transmitted from the set of pervasive devices associated with a set of users in a monitored location. The process then assigns a demographic profile to each user of the set of users based on an identity of a pervasive device from the set of pervasive devices which is associated with the user. Thereafter, the process presents a set of messages to the set of users, wherein the set of messages are selected using the demographic profile assigned to each user of the set of users.

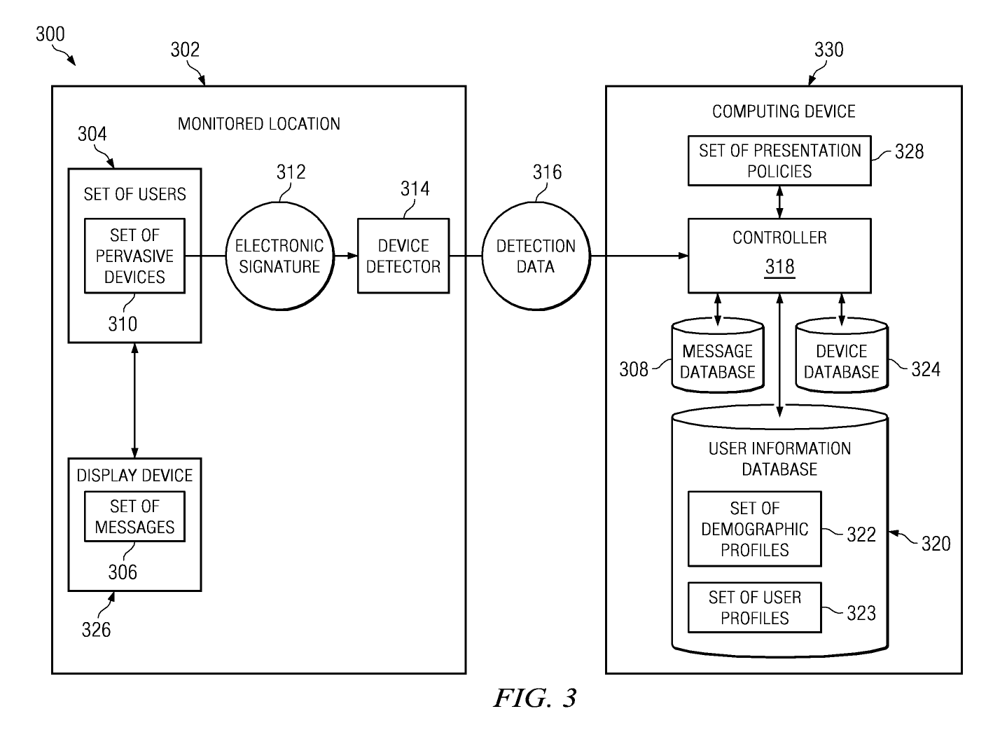

FIG. 3 is a block diagram of a system for use in presenting a set of messages to a set of users in accordance with an illustrative embodiment. System 300 is a system such as network data processing system 100 in FIG. 1. System 300 includes monitored location 302. Monitored location 302 is a monitored location such as monitored location 114 in FIG. 1.

Monitored location 302 includes set of users 304. Set of users 304 is one or more users located at or passing through monitored location 302. Set of users 304 is presented with set of messages 306. Set of messages 306 is one or more messages selected from a message database for presentation to set of users 304. Set of messages 306 may include, for example, product advertisements, stock offerings, news snippets, or any other form of information that the creator of the message would want to convey to set of users 304.

Set of messages 306 is selected from message database 308. Message database 308 is a database storing messages that may be retrieved based upon user demographics. The user demographics may be assigned to or associated with users from set of users 304 by a correlation with set of pervasive devices 310. Set of pervasive devices 310 is one or more electronic devices capable of generating and transmitting electronic signature 312 that is unique to a particular type of device. Set of pervasive devices 310 may include, for example, cell phones, personal digital assistants, digital music players, radio frequency identification tags, and other forms of electronic identification tags, or any other pervasive device.

Electronic signature 312 is a signal or transmission emitted from set of pervasive devices 310 that is unique to a particular electronic device or device type. Electronic signature 312 may include, for example, a radio frequency signal generated by a radio frequency identification tag. In addition, the electronic signal may be a wireless fidelity signal or any other form of electronic emission from a pervasive device.

Set of users 304 is in the possession of or otherwise associated with set of pervasive devices 310. For example, a user may be in the possession of a portable music player, cell phone, and laptop computer at monitored location 302. The portable music player, cell phone, and laptop computer are electronic devices that are included within set of pervasive devices 310. Similarly, the electronic devices in the possession of other users from set of users 304 are included within set of pervasive devices 310. Each pervasive device emits electronic signature 312 that may be captured and used for identifying the type of device from which the electronic signature originated.

Device detector 314 scans monitored location 302 for the electronic signals emitted from set of pervasive devices 310. Device detector 314 may be, for example, a pan adapter for scanning monitored location 302 for an electronic signal within a range of frequencies. Device detector 314 may also be a radio frequency identification tag scanner for detecting the presence of radio frequency identification tags from set of pervasive devices 310. Device detector 314 transmits detection data 316 to controller 318 for use in assigning demographic profiles to set of users 304. Controller 318 is software for selecting and presenting set of messages 306 to set of users 304 based upon user demographics. The user demographics are determined based, in part, upon the type of pervasive device or devices in the possession of the user.

Detection data 316 is data that describes the electronic signature captured from set of pervasive devices 310. In addition, detection data 316 may also include other information that may be used for selecting messages for presentation to set of users 304. For example, detection data 316 may include data describing the date and time or weather conditions present when set of pervasive devices 310 is detected. In this manner, detection data 316 may be used for selecting messages for presentation. For example, if detection data 316 indicates that it is approximately 5 p.m., then set of messages 306 may include advertisements for dinners at nearby restaurants. The type of restaurant that is included in set of messages 306 is determined by the user demographics of the user or users in possession of set of pervasive devices 310.

User demographics may be assigned to users from set of users 304 based upon the type of pervasive device in possession of the user. The association between demographic data and the one or more pervasive devices in the possession of the user may be established in any existing or later developed manner. For example, market research analysis may determine that users having certain user demographics are more likely to purchase Blackberry™ smart phones. The demographic data is data about a user that may include, for example, a common level of discretionary income, marriage status, age range, and hobbies or interests. In this manner, market research analysis may also be used to determine user demographics for users of each pervasive device in set of pervasive devices 310.

User demographics are identified by correlating set of pervasive devices with data stored in user information database 320. User information database 320 is a database storing data usable for selecting set of messages 306. The data includes set of demographic profiles 322. Set of demographic profiles 322 is one or more profiles that include demographic data. Demographic data is statistical data that describes the constituents of a given user base, and includes information such as age range, gender, education levels, and average household income. Demographics profile data stored in user information database 320 may be used to match a set of messages to set of users 304. Demographic profiles from set of demographic profiles 322 may be assigned to set of users 304 based upon an identity of set of pervasive devices 310 associated with set of users 304.

In addition, user information database 320 stores set of user profiles 323. Set of user profiles 323 is one or more profiles assigned to individual users from set of users 304. A profile from set of user profiles 323 includes information specific to a user. The information may include, for example, a credit report, a listing of the types of stores and retail items that a user purchases on a regular basis, an amount of money that the user spends on any given purchase, or other information that may be relevant in deciding which messages to present to the user. Set of user profiles 323 may be derived from membership programs implemented by grocery stores and other retail facilities, from user surveys, or other sources. Controller 318 may reference set of user profiles 323 and set of demographic profiles 322 for selecting set of messages 306 for presentation to set of users 304.

Device database 324 is a database containing records of available pervasive devices. The records may include a field for storing data identifying the device. The data for identifying the device may include, for example, the device name, serial number, type, and/or other forms of identifiers. In addition, each record may include a field storing data that identifies the electronic signature of the associated pervasive device. Thus, when controller 318 receives detection data 316 from device detector 314, controller 318 may identify the name and type of device.

Set of messages 306 are presented to set of users 304 on display device 326. Display device 326 is one or more multimedia devices for displaying set of messages 306 to set of users 304. Display device 326 may be any type of display device for presenting a text, graphic, audio, video, and/or any combination of text, graphics, audio, and video to a recipient. For example, display device 326 may be, without limitation, a computer display screen, laptop computer, a tablet personal computer, a video display screen, a digital message board, a monitor, a kiosk, a personal digital assistant, and/or a cellular telephone with a display screen.

In an alternate embodiment, set of messages 306 is presented to set of users 304 on set of pervasive devices 310. In this embodiment, set of messages 306 is transmitted to the pervasive devices in a format compatible with each pervasive device in set of pervasive devices 310. For example, if set of pervasive devices 310 includes a cell phone, then set of messages 306 may be displayed as a text message or audio message. Alternatively, if the cell phone is capable of playing videos, then set of messages 306 may be presented as a video presenting visual and/or audio information. Music players in set of pervasive devices 310 may be presented with set of messages 306 in an audio format.

Set of presentation policies 328 is one or more rules dictating the manner in which set of messages 306 is presented to set of users 304. In particular, set of presentation policies 328 is implemented when there are multiple messages for presentation. Thus, set of presentation policies 328 may dictate the order in which messages are presented, the length of time in which messages are presented, and/or if messages are presented at all. For example, set of presentation policies 328 may provide that users having selected demographics profiles may have a higher priority than other users. Consequently, if there are two groups of users present in monitored location 302, set of messages 306 may include only information directed toward the users having higher priority. Alternatively, set of messages may include messages directed to the lower priority users, but the amount of messages may be fewer or duration of the messages may be shorter.

Computing device 330 is a computing device such as client 110 or server 104 in FIG. 1. Computing device 330 hosts controller 318 for selecting and presenting set of messages 306 to set of users 304. In addition, computing device 330 includes message database 308, device database 324, user information database 320, and set of presentation policies 328 for use in selecting messages for presentation. In this illustrative example in FIG. 3, computing device 330 is located remotely from monitored location 302. In an alternate embodiment, computing device 330 may be located in monitored location 302.

In an illustrative embodiment controller 318 receives detection data 316 from device detector 314. Controller 318 then compares detection data 316 with device database 324. From this comparison, controller 318 may classify the types of devices in the possession of set of users 304 to form set of pervasive devices 310. Classification of devices enables controller 318 to identify similar devices. Thus, controller 318 may determine that half of all users from set of users 304 operate Blackberry™ devices. This information may then be used to select set of messages 306 for presentation to this set of users having Blackberry™ devices. Controller 318 then locates set of demographic profiles 322 from user information database 320. The location of set of demographic profiles 322 is made by correlating the types of devices detected in monitored location 302 with profiles stored in user information database 320. For example, operators of Blackberry™ devices may be pre-assigned one or more profiles in user information database 320 to form set of demographic profiles 322.

Controller 318 may then select set of messages 306 from message database 308 for presentation to set of users 304. In particular, set of messages 306 may be selected based upon an association of messages for set of demographic profiles 322. For example, set of demographic profiles 322 may be selected from user information database 320 as the collection of profiles designated as relevant to Blackberry™ users. Messages from message database 308 may then be selected that correspond to set of demographic profiles 322.

In addition, controller 318 may reference set of user profiles 323 for facilitating the selection of messages from message database 308. The data stored in set of user profiles 323 enables controller 318 to identify other messages from message database 308 that may be of interest to users from set of users 304. For example, even though a particular user operates a Blackberry™ device, that user may also be an avid cyclist. The fact that the user is an avid cyclist may be determined by parsing a profile from set of user profiles 323 for that particular user. Consequently, controller 318 may also present information, such as an advertisement, relating to cycling events.

After locating set of demographic profiles 322, controller 318 may reference set of presentation policies 328 for determining how to present set of messages 306 on display device 326. Set of presentation policies 328 may be used to determine which messages to present, the order in which to present them, the length of time for presentation, or any other presentation variable.

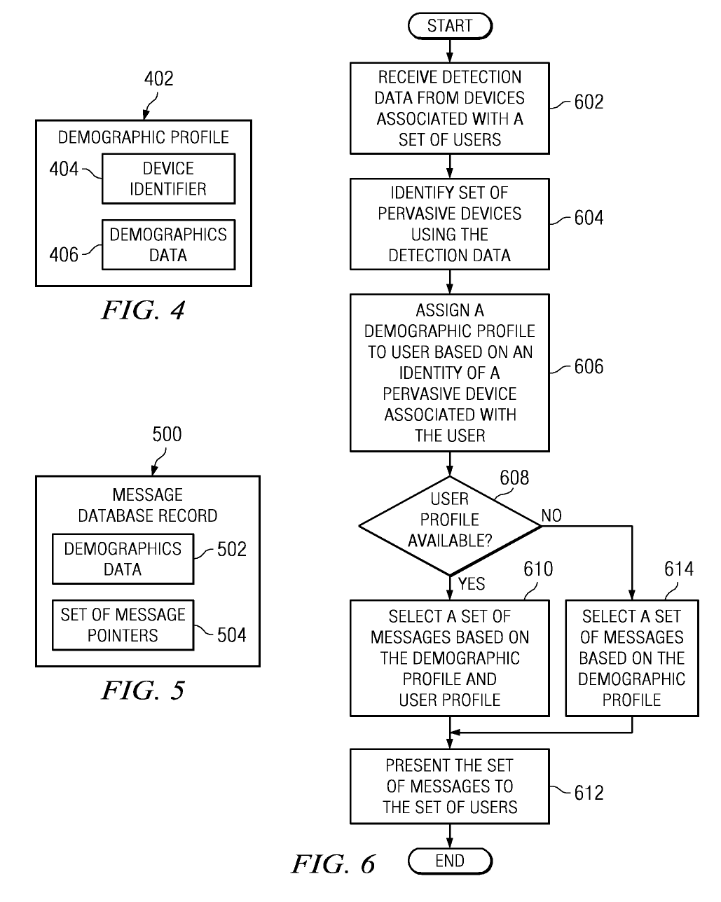

FIG. 4 is a demographic profile in accordance with an illustrative embodiment. Demographic profile 402 is a profile depicting a non-exclusive data type that may be included in a set of demographic profiles of a demographics database, such as set of demographic profiles 322 in user information database 320 in FIG. 3.

Demographic profile 402 includes device identifier 404. Device identifier 404 is a data field storing unique identifiers for identifying the one or more types of pervasive devices that a user may possess. The unique identifiers may be, for example, serial numbers, device names, or other identifying strings of alphanumeric text. Device identifier 404 may also generically indicate a type of device. The type of device may be, for example, a portable music player. Alternatively, device identifier 404 may identify the device type as an iPod™ portable music player.

Demographic profile 402 also includes demographics data 406. Demographics data 406 is a data field storing selected population characteristics data. The selected population characteristics data may include, for example, race, age, income, disabilities, educational attainment, home ownership, employment status, and geographic location. Information stored in demographics data 406 may then be subsequently used to select a set of messages for presentation to a set of users. For example, messages may be selected for users who may have a home, be of a certain age, or live in a selected geographic location.

FIG. 5 is a message database record in accordance with an illustrative embodiment. Message database record 500 is a record of a message database, such as message database 308 in FIG. 3.

Message database record 500 includes demographics data 502. Demographics data 502 is data such as demographics data 406 in FIG. 4. In this example, message database record 500 also includes set of message pointers 504. Set of message pointers 504 is one or more pointers for identifying messages stored in a message database. The messages identified by set of message pointers 504 are directed to users having the demographic characteristics stored in demographics data 502. Thus, messages may be selected from the message database for presentation to a set of users having attributes consistent with the data stored in demographics data 502. In this manner, specific messages or advertisements may be selected for only those users to whom the messages may be relevant.

In this illustrative embodiment, set of message pointers 504 may be associated with demographics data 502 in any currently used or later developed method. For example, market research exists to allow retailers to associate certain product offerings or services with a certain type of consumer. The consumer may be identified by demographics data 502. Messages may then be created targeting this type of consumer. The messages may be stored in a message database and identified by set of message pointers 504. Consequently, identification of a customer type by determining demographics data 502 enables the selection and presentation of messages that have a better chance of being favorably received by the user.

FIG. 6 is a flowchart of a process for presenting selected messages to a set of users in accordance with an illustrative embodiment. The process may be implemented in a software component such as controller 318 in FIG. 3.

The process begins by receiving detection data from devices associated with a set of users (step 602). The detection data may be received from a device detector, such as device detector 314 in FIG. 3. The detection data may include the electronic signature emitted by types of electronic devices that form the set of pervasive devices. The process then identifies the set of pervasive devices using the detection data (step 604). In particular, the identification may be made by using electronic signature in the detection data.

The process assigns a demographic profile to a user from the set of users based on an identity of a pervasive device associated with the user (step 606). The process also makes the determination as to whether a user profile is available (step 608). If the process makes the determination that the user profile is available, then the process selects a set of messages based on the demographic profile and the user profile (step 610). Thereafter, the process presents the set of messages to the set of users (step 612). The process terminates thereafter.

Returning now to step 608, if the process makes the determination that a user profile is not available, then the process selects a set of messages based on the demographic profile (step 614) and the process continues to step 612.

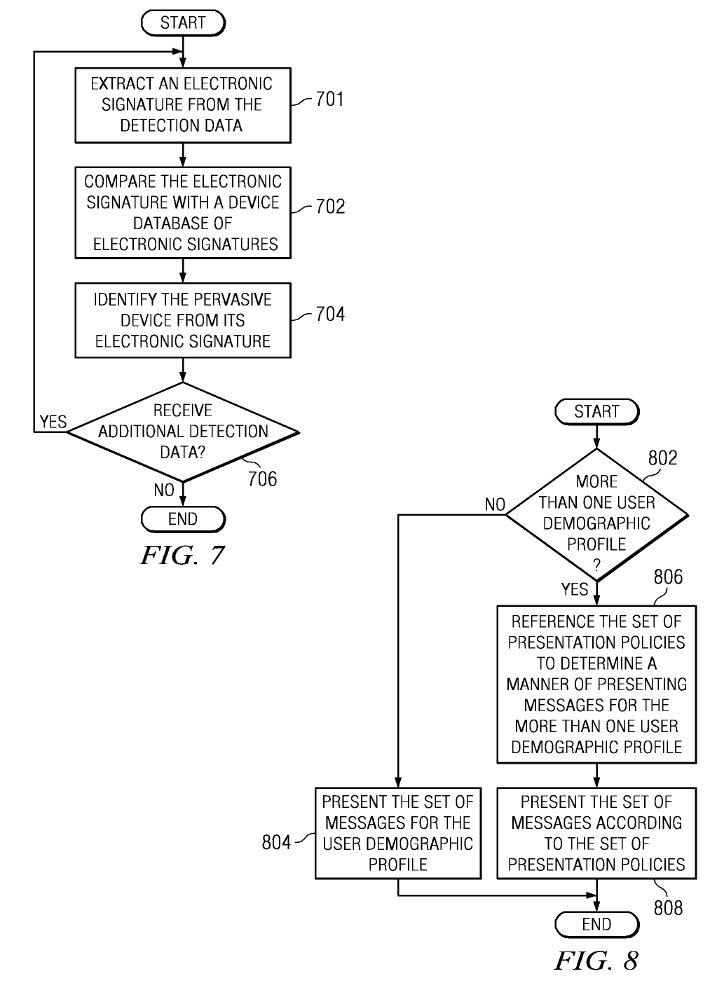

FIG. 7 is a flowchart of a process for identifying the set of pervasive devices from detection data in accordance with an illustrative embodiment. The process may be implemented in a software component such as controller 318 in FIG. 3.

The process begins by extracting an electronic signature from the detection data (701). The electronic signatures may be provided in detection data received from a device detector, such as device detector 314 in FIG. 3. The process then compares the electronic signature with a device database having a collection of electronic signatures (step 702). The process then identifies the pervasive device from the device database using its electronic signature (step 704).

Thereafter, the process makes the determination as to whether additional detection data has been received (step 706). If additional detection data has been received, then the process returns to step 701. However, if additional detection data has not been received, then the process terminates.

FIG. 8 is a process for presenting a set of messages to a set of users in accordance with an illustrative embodiment. The process may be implemented in a software component such as controller 318 in FIG. 3.

The process begins by making the determination as to whether more than one user demographic has been identified (step 802). If the process makes the determination that more than one user demographic has not been identified, then the process presents the set of messages for the user demographic (step 804) and the process terminates.

If the process makes the determination that more than one user demographic has been identified, then the process references a set of presentation policies to determine a manner of presenting the set of message to the more than one user demographic (step 806). Thereafter, the process presents the set of messages to the set of users according the set of presentation policies (step 808) and the process terminates.

Thus, the illustrative embodiments provide a computer implemented method, apparatus, and computer program product for presenting messages to a set of users based upon a set of pervasive devices of the set of users. In one embodiment, the process identifies a set of pervasive devices using detection data. The detection data comprises an electronic signature transmitted from the set of pervasive devices associated with a set of users in a monitored location. The process then assigns a demographic profile to each user of the set of users based on an identity of a pervasive device from the set of pervasive devices which is associated with the user. Thereafter, the process presents a set of messages to the set of users, wherein the set of messages are selected using the demographic profile assigned to each user of the set of users.

Demographic profiles may be assigned to users of pervasive devices. The demographic profiles may then be used to select a set of messages for presentation to the set of users. The messages selected for presentation are directed specifically to certain user demographics. As such, messages are provided that have a greater chance of being received and viewed by recipients of the messages.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The invention can take the form of an entirely hardware embodiment, an entirely software embodiment, or an embodiment containing both hardware and software elements. In a preferred embodiment, the invention is implemented in software, which includes but is not limited to firmware, resident software, microcode, etc.

Furthermore, the invention can take the form of a computer program product accessible from a computer usable or computer readable medium providing program code for use by or in connection with a computer or any instruction execution system. For the purposes of this description, a computer usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer readable medium include a semiconductor or solid-state memory, magnetic tape, a removable computer diskette, a random access memory (RAM), a read-only memory (ROM), a rigid magnetic disk, and an optical disk. Current examples of optical disks include compact disk-read only memory (CD-ROM), compact disk-read/write (CD-R/W), and DVD.

A data processing system suitable for storing and/or executing program code will include at least one processor coupled directly or indirectly to memory elements through a system bus. The memory elements can include local memory employed during actual execution of the program code, bulk storage, and cache memories, which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem, and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for presenting information, the computer implemented method comprising:
identifying a set of pervasive devices using detection data comprising an electronic signature transmitted from the set of pervasive devices, wherein the set of pervasive devices are associated with a set of users in a monitored location;
assigning a demographic profile to each user of the set of users based on an identity of a pervasive device from the set of pervasive devices which is associated with the user; and
presenting a set of messages to the set of users, wherein the set of messages are selected using the demographic profile assigned to each user of the set of users.

2. The computer implemented method of claim 1, wherein presenting the set of messages further comprises:
selecting the set of messages with reference to a user profile.

3. The computer implemented method of claim 1, further comprising:
receiving the detection data from a device detector, wherein the detection data comprises the electronic signature for identifying the set of pervasive devices.

4. The computer implemented method of claim 1, wherein identifying the set of pervasive devices comprises:
comparing the electronic signature of each pervasive device in the set of pervasive devices with a device database to identify the each pervasive device.

5. The computer implemented method of claim 1, wherein the set of pervasive devices comprises at least one of a cellular telephone, an electronic identification chip, a portable computer, a music player, and a smart phone.

6. The computer implemented method of claim 1, wherein the presenting step further comprises:
presenting the set of messages to the set of users at the monitored location.

7. The computer implemented method of claim 1, wherein the presenting step further comprises:
presenting the set of messages to the set of users based on a set of presentation policies.

8. The computer implemented method of claim 1, wherein the presenting step further comprises:
selecting messages for presentation based on information included in the detection data.

9. A computer program product for presenting information, the computer program product comprising:
a computer recordable-type medium;
first program instructions for identifying a set of pervasive devices using detection data comprising an electronic signature transmitted from the set of pervasive devices, wherein the set of pervasive devices are associated with a set of users in a monitored location;
second program instructions for assigning a demographic profile to each user of the set of users based on an identity of a pervasive device from the set of pervasive devices which is associated with the user;
third program instructions for presenting a set of messages to the set of users, wherein the set of messages are selected using the demographic profile assigned to each user of the set of users; and
wherein the first program instructions, the second program instructions, and the third program instructions are stored on the computer recordable-type medium.

10. The computer program product of claim 9, further comprising:
fourth program instructions for selecting the set of messages with reference to a user profile, wherein the fourth program instructions are stored on the computer recordable-type medium.

11. The computer program product of claim 9, further comprising:
fifth program instructions for receiving the detection data from a device detector, wherein the detection data comprises the electronic signature for identifying the set of pervasive devices, wherein the fifth program instructions are stored on the computer recordable-type medium.

12. The computer program product of claim 9, wherein the third program instructions further comprises:
program instructions for comparing the electronic signature of each pervasive device in the set of pervasive devices with a device database to identify the each pervasive device.

13. The computer program product of claim 9, wherein the set of pervasive devices comprises at least one of a cellular telephone, an electronic identification chip, a portable computer, a music player, and a smart phone.

14. The computer program product of claim 9, wherein the third program instructions further comprise:
program instructions for presenting the set of messages to the set of users at the monitored location.

15. The computer program product of claim 9, wherein the third program instructions further comprise:
program instructions for presenting the set of messages to the set of users based on a set of presentation policies.

16. The computer program product of claim 9, wherein the third program instructions further comprises:
program instructions for selecting messages for presentation based on information included in the detection data.

17. An apparatus for presenting information, the system comprising:
a bus system;
a memory connected to the bus system, wherein the memory includes computer usable program code; and
a processing unit connected to the bus system, wherein the processing unit executes the computer usable program code to identify a set of pervasive devices using detection data comprising an electronic signature transmitted from the set of pervasive devices, wherein the set of pervasive devices are associated with a set of users in a monitored location; assign a demographic profile to each user of the set of users based on an identity of a pervasive device from the set of pervasive devices which is associated with the user; and present a set of messages to the set of users, wherein the set of messages are selected using the demographic profile assigned to each user of the set of users.

18. The apparatus of claim 17, wherein the processing unit executes the computer usable program code to select the set of messages with reference to a user profile.

19. The apparatus of claim 17, wherein the processing unit executes the computer usable program code to receive the detection data from a device detector, wherein the detection data comprises the electronic signature for identifying the set of pervasive devices.

20. The apparatus of claim 17, wherein the processing unit further executes the computer usable program code to compare the electronic signature of each pervasive device in the set of pervasive devices with a device database to identify the each pervasive device.

21. A system for presenting information, the system comprising:
a device detector, wherein the device detector detects an electronic signature from a set of pervasive devices in a monitored location;
a controller, wherein the controller identifies a set of pervasive devices using detection data comprising an electronic signature transmitted from the set of pervasive devices, wherein the set of pervasive devices are associated with a set of users in a monitored location; assigns a demographic profile to each user of the set of users based on an identity of a pervasive device from the set of pervasive devices which is associated with the user; and presents a set of messages to the set of users, wherein the set of messages are selected using the demographic profile assigned to each user of the set of users.
